(19) United States
(12) Patent Application Publication
(10) Pub. No.: US 2021/0077839 A1
(43) Pub. Date: Mar. 18, 2021

(54) ASSIST DEVICE

(71) Applicant: JTEKT CORPORATION, Osaka (JP)

(72) Inventors: Tomoki ARAI, Kitakatsuragi-gun (JP); Hiromichi OHTA, Kariya-shi (JP); Kazuyoshi OHTSUBO, Chiryu-shi (JP); Yoshitaka YOSHIMI, Kashiba-shi (JP)

(73) Assignee: JTEKT CORPORATION, Osaka (JP)

(21) Appl. No.: 17/015,357

(22) Filed: Sep. 9, 2020

(30) Foreign Application Priority Data
Sep. 12, 2019 (JP) 2019-166188
Nov. 21, 2019 (JP) 2019-210238
Apr. 29, 2020 (JP) 2020-079890

(51) Int. Cl. A62B 35/00

(52) U.S. Cl. CPC A62B 35/0018; A62B 35/0031

(57) ABSTRACT

An assist device includes a first harness, a second harness, a belt body and an actuator. The first harness is configured to be fitted to at least one of a shoulder region and a breast region of a user. The second harness is configured to be fitted to left and right leg regions, respectively, or a waist region, of the user. The belt body provided so as to extend to the first harness and to the second harness along a back side of the user. The actuator is provided in the first harness or the second harness and configured to wind and unwind a part of the belt body.

### CROSS-REFERENCE TO RELATED APPLICATIONS

This application claims priority to Japanese Patent Application No. 2019-166188 filed on Sep. 12, 2019, Japanese Patent Application No. 2019-210238 filed on Nov. 21, 2019, and Japanese Patent Application No. 2020-079890 filed on Apr. 29, 2020, each incorporated herein by reference in its entirety.

### BACKGROUND

### 1. Technical Field

The present disclosure of the present disclosure relates to an assist device.

### 2. Description of Related Art

Various assist devices that assist a user's work by being worn on the body of the user (human being) have been proposed. For example, even where a user lifts a heavy object, an assist device enables the user to perform the work with a small strength (burden). Such assist device is disclosed in, for example, Japanese Unexamined Patent Application Publication No. 2018-199205 (JP 2018-199205 A).

### SUMMARY

The assist device disclosed in JP 2018-199205 A includes a frame made of, e.g., a metal, the frame being fitted to a user. An output of an actuator mounted in the frame is transmitted to the upper body and the lower body of the user through a link mechanism. Consequently, for example, a motion of lifting a heavy object is assisted.

Examples of motions for which a user needs assistance include motions of assisting (helping) a person such as a patient or an elderly person in activities of daily living in addition to motions involving a large burden such as lifting a heavy object. When a user performs work involving a heavy burden, a high-power assist device such as one disclosed in JP 2018-199205 A is effective.

However, when a user assists a person such as a patient or an elderly person, a high-power assist device may be excessive in performance. Also, a high-power assist device uses many rigid members such as a link mechanism and a frame made of, e.g., metal, and has a solid configuration in order to achieve a high output. Therefore, the assist device is heavy in weight and movement of the user is restricted by the rigid members.

The present disclosure provides an assist device that is light in weight and provides good wear comfort.

An assist device according to an aspect of the present disclosure includes a first harness, a second harness, a belt body and an actuator. The first harness is configured to be fitted to at least one of a shoulder region and a breast region of a user. The second harness is configured to be fitted to a leg region or a waist region of the user. The belt body is provided so as to extend to the first harness and to the second harness along the back side of the user. The actuator is provided in the first harness or the second harness and configured to wind and unwind a part of the belt body.

With the assist device according to the aspect of the present disclosure, the belt body is provided so as to extend to the first harness and to the second harness along the back side of a user. Upon the actuator winding the belt body, tension acts on the belt body. The tension causes generation of an assist force for assisting the user's work, which reduces a burden on the body of the user.

For example, when a user (caregiver) changes his/her posture from a forward-tilted posture to an upright posture while holding a load (care-receiver) with his/her hands, tension acts on the belt body by the actuator winding the belt body. The tension makes it easy for the user to changes his/her posture from a forward-tilted posture to a upright posture and thus reduces a burden on the body of the user.

Then, the belt body is light in weight and can conform to the body of a user even if the user changes his/her posture, and thus follows movement of the user. Therefore, an assist device that provides good wear comfort can be provided. The assist device according to the aspect of the present disclosure may include a plurality of the second harnesses. The second harnesses may be configured to be fitted respectively to right and left legs of the user. The assist device according to the aspect of the present disclosure reduces a burden on the waist region. Also, in the assist device according to the aspect of the present disclosure, the belt body may be non-stretchable. With the assist device according to the aspect of the present disclosure, a relationship between an output of the actuator and tension acting on the belt body becomes clear, which makes it easy to control a necessary assist force.

Also, in the assist device according to the aspect of the present disclosure, the actuator may be provided in the first harness. The belt body may include a first belt, a second belt attached to the second harness, and a joining member joining the first belt and the second belt. The first belt may be configured to be wound and unwound by the actuator.

With the assist device according to the aspect of the present disclosure, by the actuator winding the first belt, tension acts on the first belt and the second belt. The tension causes generation of an assist force for assisting a user's work, which reduces a burden on the body of the user.

Upon the user walking with the second harnesses attached to left and right legs of the user and the belt body tensed, the leg regions may be pulled by the belt body. Therefore, in the assist device according to the aspect of the present disclosure, the joining member may include a first attachment portion to which an end portion of the first belt is attached, and a second attachment portion configured to support the second belt in such a manner that the second belt is folded at an intermediate point of the second belt and moves in a longitudinal direction of the second belt, and one end portion side of the second belt may be attached to the second harness on the left leg region side and the other end portion side of the second belt may be attached to the second harness on the right leg region side.

With the assist device according to the aspect of the present disclosure, when a user walks, a length of a part from the joining member to the left second harness (left second belt portion) and a length of a part from the joining member to the right second harness (right second belt portion) change in the second belt. Therefore, the user can easily walk.

In the assist device according to the aspect of the present disclosure, the second attachment portion may include a shaft portion integrated with the first attachment portion, and a rotary pulley supported on the shaft portion, the second belt being hung on the rotary pulley in such a manner that the second belt is folded at an intermediate point of the second belt. With the assist device according to the aspect of the present disclosure, the rotary pulley makes the length of the left second belt portion and the length of the right second belt portion easily change when a user walks, and thus, the user can more easily walk.

Also, in the assist device according to the aspect of the present disclosure, the second belt may include a left second belt portion extending from the joining member to the second harness on the left leg region side, a right second belt portion extending from the joining member to the second harness on the right leg region side, and a connecting member connecting the left second belt portion and the right second belt portion. With the assist device according to the aspect of the present disclosure, for example, when a user changes his/her posture, an increase in lateral distance between the left second belt portion and the right second belt portion can be prevented. In other words, a failure of the left second belt portion and the right second belt portion to extend along the back side (respective back sides of leg regions) of the user can be prevented.

Upon the user walking, a length from the part of joining between the connecting member and the left second belt portion to the joining member and a length from the part of joining between the connecting member and the right second belt portion to the joining member vary and thus become different from each other. Therefore, in the assist device according to the aspect of the present disclosure, the connecting member and the left second belt portion may be joined so as to rotate relative to each other, and the connecting member and the right second belt portion may be joined so as to rotate relative to each other. The assist device according to the aspect of the present disclosure makes it difficult for movement of the second belt to be hindered by the connecting member.

In the assist device according to the aspect of the present disclosure, the connecting member may include a left support portion including a passage configured to allow the left second belt portion to extend through the passage, a right support portion including a passage configured to allow the right second belt portion to extend through the passage, a center support portion connecting the left support portion and the right support portion, and a hanging portion configured to hold the center support portion in such a manner that the center support portion hangs from the joining member. Upon the user walking, the left second belt portion and the right second belt portion, which are folded at the joining member, each vary in length. With the assist device according to the aspect of the present disclosure, the passages prevent restriction of displacement in a longitudinal direction of the left second belt portion and the right second belt portion. The left support portion and the right support portion including such passages as above allow free movement in the longitudinal direction of the second belt. Then, the center support portion enables preventing an increase in lateral distance between the left second belt portion and the right second belt portion.

Also, in the assist device according to the aspect of the present disclosure, the first harness may include a shoulder belt having flexibility and a stiff member that is more rigid than the shoulder belt and is to be hung on the shoulder region of the user. The stiff member may include a pad portion provided along the shoulder belt. With the assist device according to the aspect of the present disclosure, the first harness is fitted to a shoulder region of a user. The stiff member being hung on the shoulder region enhances a function that, when tension acts on the belt body, prevents the first harness from slipping off.

The assist device according to the aspect of the present disclosure enables provision of a device that is light in weight and provides good wear comfort.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1 is a back view illustrating an example of an assist device;

FIG. 2 is a back view of the assist device attached to the body of a user;

FIG. 3 is a side view of the assist device attached to the body of the user;

FIG. 4 is a diagram illustrating the user wearing the assist device in a forward-tilted posture;

FIG. 5 is a diagram of a control box and a belt body;

FIG. 6 is diagram of a case where a user wearing an assist device changes his/her posture;

FIG. 7 is a diagram of parts of attachment of a second belt to second harnesses;

FIG. 8 is a diagram of a second belt and a connecting member;

FIG. 9 is side view illustrating another form of assist device;

FIG. 10 is a diagram of a first harness as viewed from the back side;

FIG. 11 is a back view of a stiff member;

FIG. 12 is a perspective view of the stiff member;

FIG. 13 is a diagram illustrating an alteration of the connecting member;

FIG. 14 is a diagram illustrating an alteration of the first harness and is a diagram of that first harness as viewed from the front;

FIG. 15 is a diagram of the first harness illustrated in FIG. 14 as viewed from the back;

FIG. 16 is an overall view of an assist device including a first harness and second harnesses;

FIG. 17 is a diagram of a second harness; and

FIG. 18 is a diagram illustrating a developed state of the second harness illustrated in FIG. 17.

### DETAILED DESCRIPTION OF EMBODIMENTS

Overall Configuration of Assist Device 10

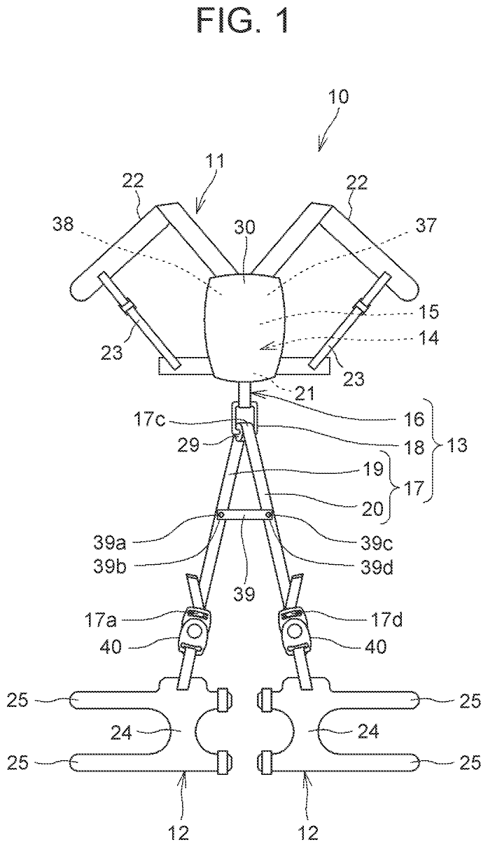

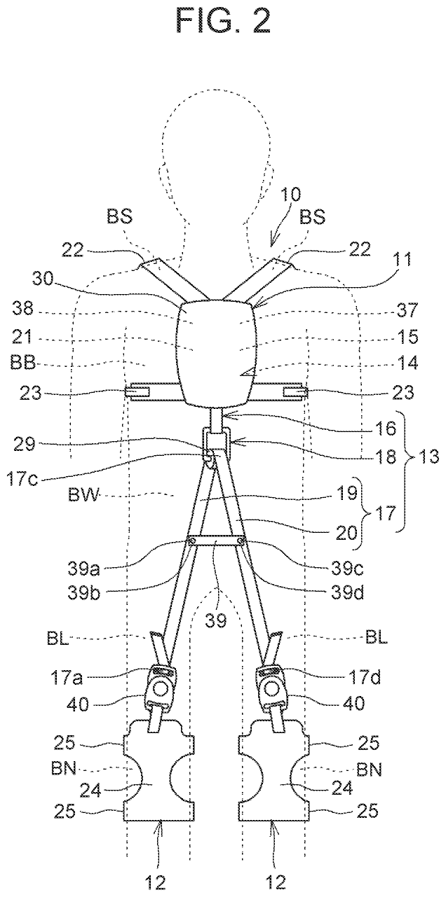

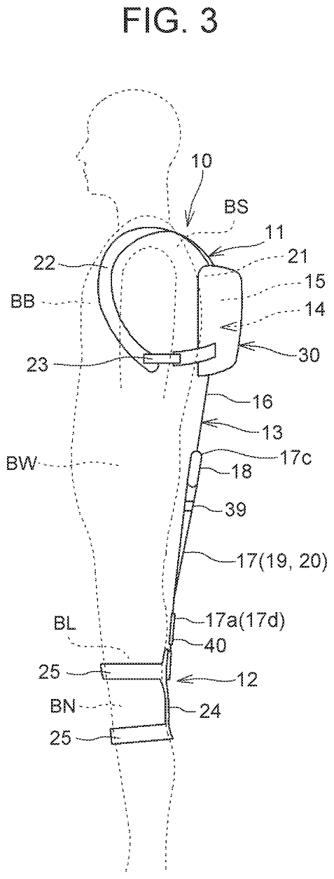

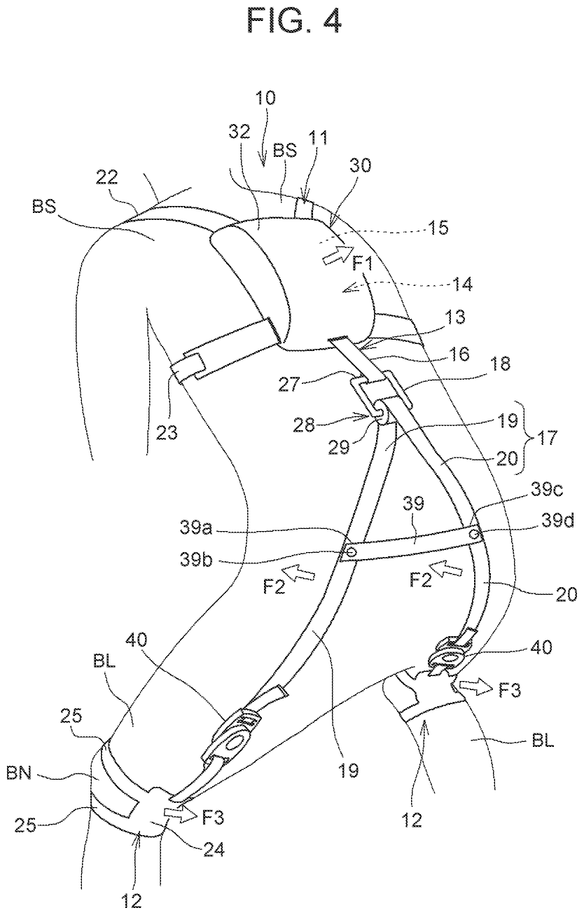

FIG. 1 is a back view illustrating an example of an assist device. FIG. 2 is a back view of the assist device attached to the body of a user. FIG. 3 is a side view of the assist device attached to the body of the user. FIG. 4 is a diagram illustrating the user wearing the assist device having a forward-tilted posture (stooped posture). The assist device 10 illustrated in FIG. 1 includes one first harness 11 to be fitted to left and right shoulder regions BS, which are parts of the body of a user (human being), and two second harnesses 12 to be fitted to left and right leg regions BL, which are other parts of the body of the user. The first harness 11 only needs to be fitted to at least either the shoulder regions BS or a breast region BB of the user, and also, may have a form other than the illustrated form. In the present disclosure, the second harnesses 12 are fitted to respective knee regions BN in the leg regions BL. The second harnesses 12 also may have a form other than the illustrated form.

In the assist device 10 of the present disclosure, “left” and “right” are the user's own left and right when the user has an upright posture wearing the assist device 10 and “front” and “rear” are the user's own front and rear, “upper (up)” and “lower (down)” are the user's own upper and lower sides. “Upper (up)” are the head side of the user and “lower (down)” are the foot side of the user.

The assist device 10 includes a belt body 13, an actuator 14, a controller 15, a battery 37 and a sensor 38 in addition to the first harness 11 and the left and right second harnesses 12.

The first harness 11 is fitted to the shoulder region BS of the user. One second harness 12 is fitted to the left knee region BN of the user. The other second harness 12 is fitted to the right knee region BN of the user. The left second harness 12 and the right second harness 12 are bilaterally symmetrical and have a same configuration. The first harness 11 and the two second harnesses 12 are fitted to respective regions away from each other across a waist region BW, which is a joint of the user, that is, the shoulder regions BS and the leg regions BL.

The first harness 11 is formed of, e.g., flexible fabric. The first harness 11 includes a back body portion 21 to be fitted to the back of the user, and shoulder belts 22 and underarm belts 23 connecting with the back body portion 21. The shoulder belts 22 and the underarm belts 23 allow the back body portion 21 to be held on the back of the user. The underarm belts 23 connect the back body portion 21 and the respective shoulder belts 22 and are adjustable in length. By adjustment of the length of each underarm belt 23, the back body portion 21 is brought into close contact with the user. The first harness 11 is fitted to the shoulder regions BS so as to be incapable of moving forward and backward, leftward and rightward, and upward and downward. The first harness 11 may include a stiff member, for example, as a part to be hung on the shoulder regions BS. The stiff member will be described later.

The second harnesses 12 are each formed of, e.g., flexible fabric. Each second harness 12 includes a knee body portion 24 to be fitted to the rear side of the relevant knee region BN of the user, and knee belts 25 provided so as to extend from the knee body portion 24. The knee belts 25 extend around the knee region BN at respective positions above and below the knee region BN, and the distal end side of each knee belt 25 is fixed to the knee body portion 24. The knee belt 25 can be adjusted in length of wrapping of the knee region BN, by a locking member such as a belt and a buckle or a hook-and-loop fastener. By the adjustment, the knee body portion 24 is brought into a close contact with the rear side of the knee region BN. The second harnesses 12 are fitted to the knee regions BN so as to be incapable of moving forward and backward, leftward and rightward, and upward and downward.

The belt body 13 is provided along the back side of the user so as to connect the first harness 11 and the second harness 12. The belt body 13 includes a first belt 16 provided on the upper body side, a second belt 17 provided on the lower body side, and a joining member 18 joining the first belt 16 and the second belt 17. Each of the first belt 16 and the second belt 17 is long and flexible. The joining member 18 is made of a metal and is formed by a rectangular ring-like body called “rectangular ring”. The joining member 18 may be a member other than the rectangular ring and may be a fastener such as a buckle. Where the joining member 18 is a buckle, the first belt 16 and the second belt 17 are attached to upper and lower loop portions (hole portions) of the buckle, respectively. Where the joining member 18 is a buckle, for example, when the second belt 17 is to be washed, the joining member 18 can be detached from the first belt 16, which is highly convenient. The joining member 18 formed of, e.g., a rectangular ring or a buckle may be made of resin other than metal.

Each of the first belt 16 and the second belt 17 is a band-like member made of fabric or leather and is bendable along a shape of the body. Note that each of the first belt 16 and the second belt 17 may be a string-like belt (wire-like member). Each of the first belt 16 and the second belt 17 of the present disclosure is a non-stretchable member, that is, has a characteristic of being hard to stretch in a longitudinal direction of the first belt 16 or the second belt 17 or a characteristic of not stretching in the longitudinal direction. Note that the belt body 13 does not need to be a non-stretchable member in its entirety but may be partly non-stretchable. In other words, a part of the belt body 13 (for example, the second belt 17) may be stretchable (elastically stretchable).

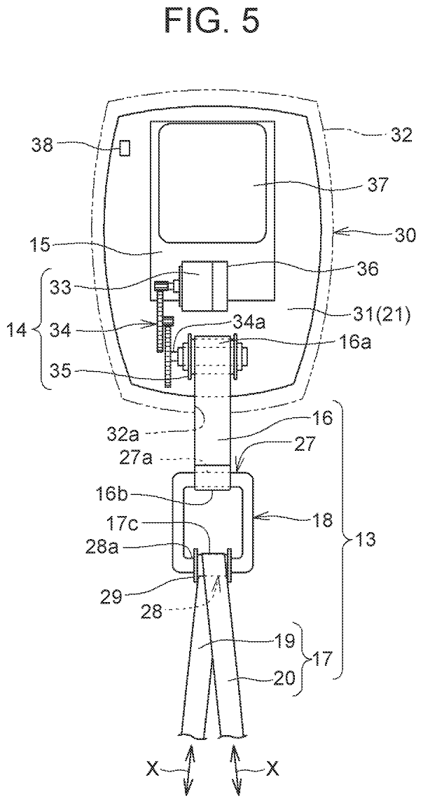

The assist device 10 of the present disclosure includes a control box 30. The control box 30 is provided in the back body portion 21 of the first harness 11. FIG. 5 is a diagram of the control box 30 and the belt body 13. The control box 30 includes a base 31 having a plate-like shape and a cover 32 that covers the base 31. In order to describe an inner structure of the control box 30, in FIG. 5, the cover 32 is indicated by an imaginary line (alternate long and two short dashes line). The base 31 may be the back body portion 21 of the first harness 11.

The actuator 14, the controller 15, the battery 37, the sensor 38, etc., are provided in space between the base 31 and the cover 32. In the cover 32, an opening (cutout) 32a is formed and the first belt 16 extends through the opening 32a.

The actuator 14 is provided inside the control box 30. In other words, the actuator 14 is provided in the first harness 11. The actuator 14 enables winding and unwinding of a part of the belt body 13. For that purpose, the actuator 14 includes a motor 33, a reducer section 34 and a drive pulley 35. The motor 33 is a brushless DC motor. The motor 33 can rotate with a predetermined torque at a predetermined rotation frequency based on a drive signal output from the controller 15. The motor 33 can rotate in forward and reverse directions based on a drive signal output from the controller 15.

A parameter relating to rotation, such as a rotational angle, a rotation speed or a rotation frequency, of the motor 33 is detected by a rotation detector 36 attached to the motor 33. The rotation detector 36 of the present disclosure is a rotary encoder but may be a Hall sensor or a resolver. A result of detection by the rotation detector 36 is input to the controller 15. By the controller 15 controlling operation of the motor 33 based on the result of detection, the assist device 10 can generate a proper assist force.

The reducer section 34 is formed by a plurality of gears, reduces the rotation frequency of the motor 33 and rotates an output shaft 34a of the reducer section 34. The drive pulley 35 is joined to the output shaft 34a and thus rotates together with the output shaft 34a. One end portion 16a side of the first belt 16 is attached to the drive pulley 35. Upon the drive pulley 35 rotating in one direction by forward rotation of the motor 33, the first belt 16 is wound on the drive pulley 35. Upon the drive pulley 35 rotating in the other direction by reverse rotation of the motor 33, the first belt 16 is unwound from the drive pulley 35.

As above, the actuator 14 includes the drive pulley 35 that can wind the belt body 13, and the motor 33 for making the drive pulley 35 perform an operation of winding the belt body 13. The first belt 16 is wound and unwound by the actuator 14.

The controller 15 is formed of a control unit including a microcomputer. The controller 15 controls operation of the actuator 14 (motor 33). As the sensor 38, an acceleration sensor is provided. A signal from the sensor 38 is input to the controller 15. The controller 15 can estimate a posture of the user based on the signal from the sensor 38. The battery 37 supplies electric power to the controller 15, the motor 33, the rotation detector 36 and the sensor 38. The sensor 38 may be provided outside the control box 30.

Belt Body 13

As described above, the belt body 13 includes a first belt 16, a second belt 17 and a joining member 18. One end portion 16a side of the first belt 16 is wound on the drive pulley 35 and is fixed. The other end portion 16b side of the first belt 16 is fixed to the joining member 18. Upon the first belt 16 being wound on the drive pulley 35, the joining member 18 is pulled up. Upon the joining member 18 being forcibly pulled down, the first belt 16 is unwound (pulled out) from the drive pulley 35. An amount of winding or unwinding (pullout) of the first belt 16 in the drive pulley 35 and an amount of rotation of an output shaft of the motor 33 are correlated with each other. A parameter relating to rotation of the motor 33 accompanying winding or unwinding of the belt body 13 is detected by the rotation detector 36.

As described above, the joining member 18 is formed by a rectangular ring-like body. A shaft portion 27a on one side (upper side) of the ring-like body is a first attachment portion 27, and the end portion 16b of the first belt 16 is attached to the first attachment portion 27. In the present disclosure, the first belt 16 is undetachable from the first attachment portion 27, but may be detachable by use of, e.g., a buckle.

The other side (lower side) of the rectangular ring-like body forming the joining member 18 is a second attachment portion 28 for attaching the second belt 17. As described above, the joining member 18 includes the first attachment portion 27 for attaching the first belt 16 and the second attachment portion 28 for attaching the second belt 17.

The second attachment portion 28 supports the second belt 17 in such a manner that the second belt 17 is folded at an intermediate point (intermediate portion 17c) of the second belt 17. The second attachment portion 28 of the present disclosure includes a shaft portion 28a integrated with the first attachment portion 27, and a rotary pulley 29 rotatably supported on the shaft portion 28a. The second belt 17 is hung on the rotary pulley 29 so as to be folded at an intermediate point of the second belt 17. This configuration provides a configuration in which the second belt 17 is not fixed to the second attachment portion 28 but the second belt 17 is supported so as to be movable in both directions in the longitudinal direction (arrow X directions in FIG. 5) in a state in which the second belt 17 is folded.

In FIG. 2, the second belt 17 is attached to the second harnesses 12. More specifically, the second belt 17 is formed of a single band-like member. One end portion 17a side of the second belt 17 is attached to the left second harness 12. The other end portion 17d side of the second belt 17 is attached to the right second harness 12. As above, the intermediate portion 17c of the second belt 17 is put on the joining member 18.

According to the above configuration of the second belt 17, the second belt 17 includes a left second belt portion 19 extending from the joining member 18 to the left second harness 12 and a right second belt portion 20 extending from the joining member 18 to the right second harness 12. As above (see FIG. 5), the second belt 17 is hung on the second attachment portion 28 (rotary pulley 29) and not fixed, a length of the left second belt portion 19 and a length of the right second belt portion 20 can freely be changed. However, a total of the length of the left second belt portion 19 and the length of the right second belt portion 20 is fixed. This configuration prevents, for example, walking of the user from being restricted by the second belt 17, and thus, enables the user to easily walk.

The second belt 17 further includes a connecting member 39 connecting the left second belt portion 19 and the right second belt portion 20. The connecting member 39 connects the left second belt portion 19 and the right second belt portion 20 at intermediate positions between the folded portion (intermediate portion 17c) of the second belt 17 and respective fixation parts of the two second harnesses 12 (one end portion 17a and the other end portion 17d). The folded portion is a part of the second belt 17, the part being folded at the joining member 18. The fixation portions are parts of the second belt 17, the parts being fixed to the two second harnesses 12, respectively.

For example, where the user changes his/her posture from an upright posture to a stooped posture as illustrated in FIG. 4, the connecting member 39 enables preventing an increase in lateral distance between the left second belt portion 19 and the right second belt portion 20. In other words, the connecting member 39 enables preventing a failure of the left second belt portion 19 and the right second belt portion 20 to extend along the respective back sides of the leg regions BL of the user.

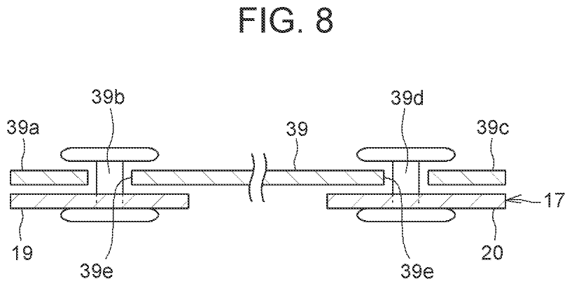

The connecting member 39 is a band-like member. As illustrated in FIG. 8, one end portion 39a of the connecting member 39 and the left second belt portion 19 are joined via, for example, a short pin 39b so as to be rotatable relative to each other. The other end portion 39c of the connecting member 39 and the right second belt portion 20 are joined via, for example, a short pin 39d so as to be rotatable relative to each other. This configuration enables preventing the connecting member 39 from making it difficult for the user to walk.

In other words, upon the user walking, in FIG. 2, a length from the joining part (pin 39b) between the connecting member 39 and the left second belt portion 19 to the joining member 18 and a length from the joining part (pin 39d) between the connecting member 39 and the right second belt portion 20 to the joining member 18 vary and thus become different from each other. Therefore, the above configuration makes it difficult for such movement of the second belt 17 to be hindered by the connecting member 39.

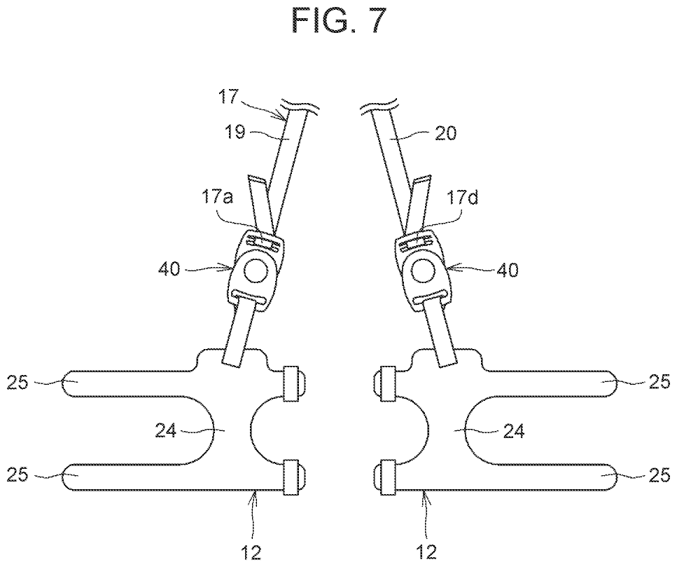

As illustrated in FIG. 7, the one end portion 17a side of the second belt 17 may be attached to the left-side second harness 12 via a fastener 40 such as a buckle. Also, the other end portion 17d side of the second belt 17 may be attached to the right-side second harness 12 via a fastener 40 such as a buckle. Consequently, the second belt 17 can be separated from the second harnesses 12.

In FIG. 8, the connecting member 39 is preferably detachable from one or both of the left second belt portion 19 and the right second belt portion 20. One or each of both of the one end portion 39a and the other end portion 39c of the connecting member 39 includes, for example, an elongated hole 39e and is detachable from the second belt 17 (pins 39b, 39d). Consequently, the second belt 17 can be separated from the joining member 18 (first belt 16). The connecting member 39 may take another form and such other form will be described later.

Sensor 38 and Controller 15

In FIG. 5, as described above, the sensor 38 is formed by an acceleration sensor. The controller 15 can perform various types of arithmetic processing. By the controller 15 performing arithmetic processing of a signal from the sensor 38, a motion and a posture of the user can be detected. The sensor 38 has a configuration that outputs a signal according to a posture of the user, and thus functions as a posture detector for detecting a posture of the user. For example, it is possible to detect whether a posture of the upper body of the user is a forward-tilted posture or an upright posture or detect that the user has taken a crouching posture.

Also, an amount of winding and unwinding of the belt body 13 in the drive pulley 35 by the motor 33 and a posture of the user are correlated with each other. Therefore, the controller 15 can estimate a posture of the user based on a rotational angle of the motor 33 detected by the rotation detector 36. The rotation detector 36 functions as a posture detector for detecting a posture of the user.

The controller 15 processes a signal from one or each of both of the sensor 38 and the rotation detector 36, and outputs a drive signal to the actuator 14 (motor 33) based on a result of the processing, that is, the posture of the user. Based on the drive signal, the actuator 14 (motor 33) operates to, e.g., wind and unwind the belt body 13 and temporarily stop the winding and unwinding.

In a state in which the assist device 10 is worn by the user, the motor 33 constantly operates (generates torque) in a direction in which the belt body 13 is wound, with a force that is smaller than that of a case where the motor 33 generates an assist force, according to the control by the controller 15, to cause generation of small tension in the belt body 13. Consequently, the belt body 13 is not loosened.

Upon the user changing his/her posture, for example, from an upright posture to a forward-tilted posture, tension is generated in the belt body 13 because of the posture change. Therefore, in this case, upon a start of a posture change to a forward-tilted posture, the motor 33 is forcibly rotated (the motor 33 idles) by the tension of the belt body 13 irrespective of power of the actuator 14, and the belt body 13 is thereby unwound. Alternatively, upon a start of a posture change to a forward-tilted posture, the actuator 14 operates, that is, the motor 33 is driven to rotate to unwind the belt body 13.

On the other hand, upon the user changing his/her posture from a forward-tilted posture to an upright posture, the belt body 13 is about to be loosened because of the posture change. Therefore, in this case, upon a start of the posture change to an upright posture, in order to maintain tension acting on the belt body 13, the actuator 14 operates, that is, the motor 33 is driven to rotate, to wind the belt body 13.

In this way, by the user's posture change, the belt body 13 is wound or unwound. In the winding or the unwinding, the motor 33 actively or passively rotate by a predetermined rotational angle. The rotational angle at this time is detected by the rotation detector 36. In this way, an amount of operation of the actuator 14 (motor 33) in winding or unwinding of the belt body 13 due to the user's posture change is detected by the rotation detector 36. Then, the controller 15 acquires the amount of operation of the actuator 14 (rotational angle of the motor 33) in winding or unwinding of the belt body 13 due to the user's posture change, and based on the amount of operation, performs control of operation of the actuator 14 in order to provide an assist force to the user.

Assist Force of Assist Device 10

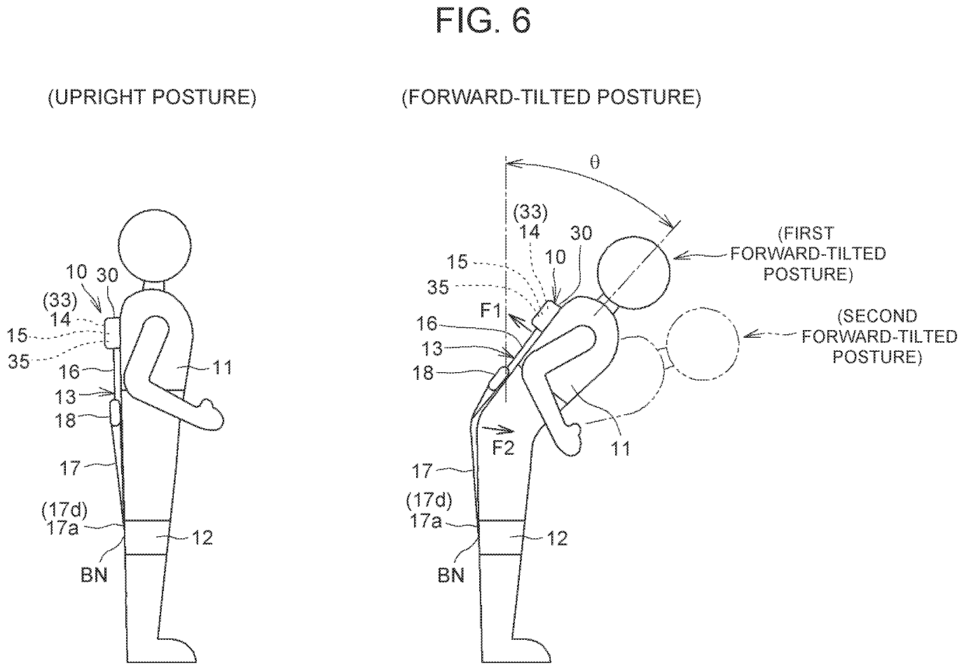

FIG. 6 is a diagram of a case where the user wearing the assist device 10 changes his/her posture. The assist device 10 can provide an assist force to the user for the posture change.

Upon the first belt 16 being wound on the drive pulley 35 by the motor 33 of the actuator 14, the joining member 18 pulls the second belt 17 up toward the actuator 14 side, that is, the upper side. The opposite end portions 17a, 17d of the second belt 17 are attached to the left and right second harnesses 12, respectively. The second harnesses 12 are fixed to the respective knee regions BN. Therefore, upon the first belt 16 being wound on the drive pulley 35, tension acts on the first belt 16 and the second belt 17. The tension acts as an assist force for the user.

A case where the user changes his/her posture from an upright posture to a forward-tilted posture will be described. Upon a start of the posture change to a forward-tilted posture, the actuator 14 unwinds the belt body 13. Alternatively, the belt body 13 is unwound irrespective of power of the actuator 14. Consequently, the user can effortlessly take a forward-tilted posture. Upon a forward-tilting angle of the upper body of the user relative to a vertical line reaching θ and the user stopping at the tilting angle of θ, the unwinding of the belt body 13 is stopped. Note that a start and an end of a posture change can be detected by the rotation detector 36 or the sensor 38.

Upon the user starting to change his/her posture in a direction from a forward-tilted posture to an upright posture, the actuator 14 winds the belt body 13. Consequently, tension is generated in the belt body 13. The tension causes generation of a rearward acting force F1 in the first harness 11. In other words, an acting force F1 is generated in a direction in which the upper body of the user having a forward-tilted posture is raised. Also, simultaneously, in the second belt 17, an acting force F2 pushing a left hip region and a right hip region of the user forward is generated by the tension. Consequently, the user can easily return from the forward-tilted posture to an upright posture.

Also, as illustrated in FIG. 4, where the user takes a bent posture (crouching posture) in which the upper body is tilted forward and the knee regions are bent, the assist device 10 can provide an assist force to the user. Where the user changes his/her posture from a bent posture to an upright posture, for example, where the user lifts up an object or a part of the body of a care-receiver, the actuator 14 winds the belt body 13. Consequently, tension is generated in the belt body 13.

The tension causes generation of a rearward acting force F1 in the first harness 11. In other words, an acting force F1 in a direction in which the upper body of the user having a forward-tilted posture is raised is generated. Also, simultaneously, in the second belt 17, an acting force F2 pushing the left hip region and the right hip region of the user forward is generated by the tension. Furthermore, a rearward acting force F3 is generated in the second harnesses 12. The above acting forces F1, F2, F3 reduce a load on muscles such as the back muscle, the quadriceps, etc., of the user having a stooped posture and thus enables assisting a motion of lifting up a load.

The assist device 10 also functions where the user changes his/her posture from an upright posture into a bent posture, for example, where the user lifts down an object or a part of the body of a care-receiver. In this case, the actuator 14 unwinds the belt body 13 while exerting a braking force for the unwinding of the belt body 13. In other words, the motor 33 rotates in a direction in which the belt body 13 is unwound, but torque in the winding direction is generated in the motor 33. Consequently, tension is generated in the belt body 13. In this case, also, the assist device 10 enables reducing a load on muscles such the back muscle, the quadriceps, etc., of the user in a stooped posture and thus enabling assisting a lift-down motion by means of the above acting forces F1, F2, F3. As above, the assist device 10 of the present disclosure enables reducing a load on the muscles of the waist region in a stooped posture and preventing lower back pain.

Also, according to the assist device 10 of the present disclosure, even if the user has a bent posture with one of the left and right leg regions BL on the front side and the other on the rear side (in a laterally asymmetrical state), one (on the side on which the leg region is put forward) of the left second belt portion 19 and the right second belt portion 20 of the second belt 17 can automatically become longer than the other. Upon the first belt 16 being wound by the actuator 14 in this state, tension also acts on the second belt 17, and the tension acts on both of the left second belt portion 19 and the right second belt portion 20 and thus the tension is not relieved. Therefore, as described above, even if the user has a laterally asymmetrical posture, the assist device 10 of the present disclosure enables a proper assist force to act on the user.

Where the user maintains a forward-tilted posture, also, the assist device 10 of the present disclosure enables easily maintaining the posture. In other words, as illustrated in the figure on the right side of FIG. 6, in a state in which the user has taken a first forward-tilted posture, the operation of the actuator 14 stops to prevent unwinding of the belt body 13. Even if the user attempts to take a further forward-tilted posture (second forward-tilted posture), tension of the belt body 13 connecting the first harness 11 and the second harnesses 12 prevents taking the second forward-tilted posture. In other words, the assist device 10 attempts to maintain the first forward-tilted posture of the user. For the user, it is easy to maintain the first forward-tilted posture. As a result, for example, where the user continues having the first forward-tilted posture for a long time for work, a load on the body can be reduced.

Assist Device 10 of the Present Disclosure

As above, the assist device 10 of the present disclosure (see FIG. 2) includes the first harness 11 to be fitted to shoulder regions BS of a user, the second harnesses 12 to be fitted to left and right leg regions BL of the user, respectively, the belt body 13, and the actuator 14. The belt body 13 is provided so as to extend to the first harness 11 and to the second harnesses 12 along the back side of the user. The actuator 14 is provided in the first harness 11 and is configured to be capable of winding and unwinding a part of the belt body 13.

The belt body 13 includes the first belt 16 to be wound and unwound by the actuator 14, the second belt 17 attached to the second harnesses 12, and the joining member 18 joining the first belt 16 and the second belt 17.

According to this assist device 10, the belt body 13 is provided so as to extend to the first harness 11 and to the second harnesses 12 along the back side of a user. By the actuator 14 winding the belt body 13 (first belt 16), tension acts on the first belt 16 and the second belt 17. The tension causes generation of an assist force for assisting the user's work, which reduces a burden on the body of the user.

For example, when a user (caregiver) changes his/her posture from a forward-tilted posture to an upright posture while holding a load (care-receiver) with his/her hands (see FIG. 6), tension acts on the belt body 13 by the actuator 14 winding the belt body 13. The tension makes it easy for the user to change his/her posture from a forward-tilted posture to an upright posture and thus reduces a burden on the body of the user. In other words, tension acting on the belt body 13 is generated by the actuator 14 as an assist force. Also, the belt body 13 of the present disclosure is non-stretchable over an entire length. Consequently, a relationship between an output of the actuator 14 and tension acting on the belt body 13 becomes clear, which makes it easy to control a necessary assist force.

Upon the user walking with the second harnesses 12 attached to the leg regions BL of the user and the belt body 13 tensed, the leg regions BL may be pulled by the belt body 13. In the second belt 17, if each of the length of the left second belt portion 19 and the length of the right second belt portion 20 is always constant and fixed, the user may feel discomfort in walking. Therefore, in the present disclosure, the one end portion 17a side of the second belt 17 is attached to the left second harness 12 and the other end portion 17d side of the second belt 17 is attached to the right second harness 12. Then, the second attachment portion 28 included in the joining member 18 supports the second belt 17 in such a manner that the second belt 17 is folded at an intermediate point of the second belt 17 and movable in the longitudinal direction.

With this configuration, when the user walks, the length of the left second belt portion 19 and the length of the right second belt portion 20 change in the second belt 17. Therefore, the user can easily walk.

Furthermore, in the present disclosure, as illustrated in FIG. 5, the second attachment portion 28 of the joining member 18 includes the rotary pulley 29 supported on the shaft portion 28a integrated with the first attachment portion 27. The second belt 17 is hung on the rotary pulley 29 so as to be folded at an intermediate point of the second belt 17. Therefore, when the user walks, the length of the left second belt portion 19 and the length of the right second belt portion 20 easily change and thus the user can more easily walk.

Other Assist Devices 10

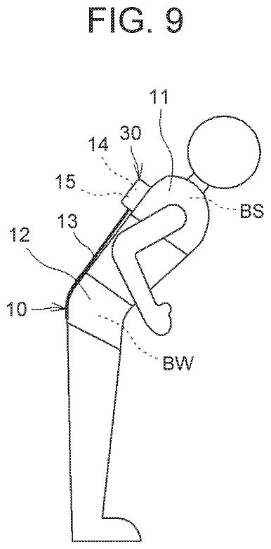

In the assist device 10 disclosed above, the second harnesses 12 are fitted to the leg regions BL of the user. As illustrated in FIG. 9, a second harness 12 may be fitted to a waist region BW of a user. In this case, the second harness 12 may have the shape of a waist belt or the shape of pants. Where a second harness 12 is fitted to a waist region BW, an actuator 14 may be attached to a first harness 11 or may be attached to the second harness 12. In FIG. 9, an actuator 14 is attached to a first harness 11.

In the case of the assist device 10 illustrated in FIG. 9, also, a belt body 13 is provided so as to extend to the first harness 11 and to the second harness 12 along the back side of the user. By the actuator 14 winding the belt body 13, tension acts on the belt body 13. The tension causes generation of an assist force for assisting the user's work, which reduces a burden on the body of the user.

Stiff Member Included in First Harness 11

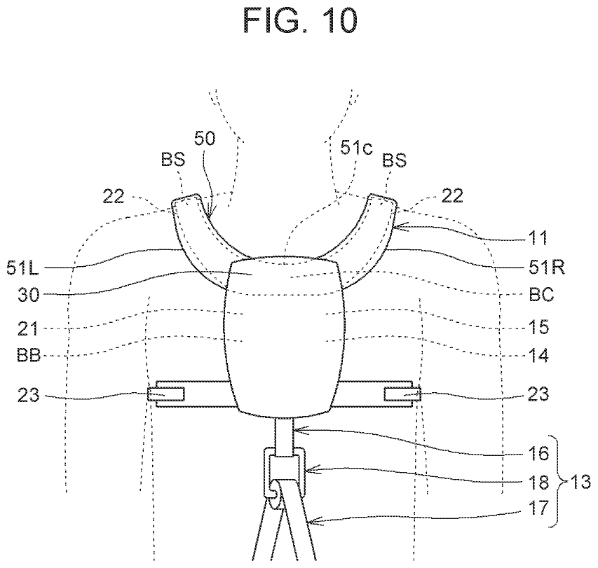

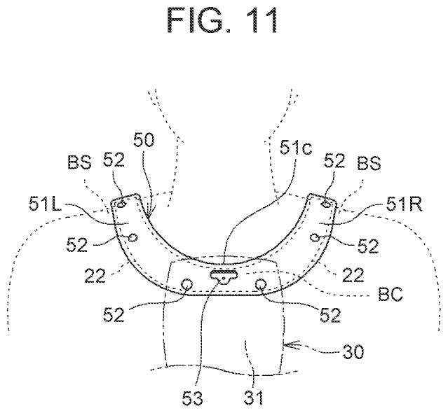

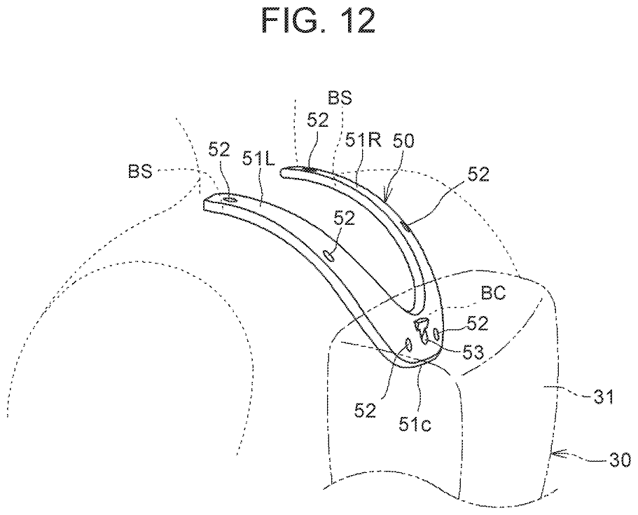

FIG. 10 is a diagram of a first harness 11 as viewed from the back side. As above, a first harness 11 may include a stiff member 50 as a part to be hung on shoulder regions BS. FIG. 11 is a back view of the stiff member 50 and FIG. 12 is a perspective view of the stiff member 50. The stiff member 50 is made of, for example, resin and is more rigid than shoulder belts 22. The shoulder belts 22 are each formed of a flexible belt member. The stiff member 50 has a shape extending from a back BC of a user along the left and right shoulder regions BS. The stiff member 50 includes left and right pad portions 51L, 51R, and a center pad portion 51C connecting the pad portions 51L, 51R, and has a U-shape as a whole.

As illustrated in FIGS. 11 and 12, the left pad portion 51L includes a part that can be in contact with the left shoulder region BS of the user from above. The right pad portion 51R includes a part that can be in contact with the right shoulder region BS of the user from above. The center pad portion 51C includes a part that can be in contact with the back BC of the user from the back side. In FIG. 11, at least left and right pad portions 51L, 51R are provided along the left and right shoulder belts 22, respectively. The shoulder belts 22 may be provided between the shoulder regions BS of the user and the stiff member 50 (pad portions 51L, 51R), or the stiff member 50 (pad portions 51L, 51R) may be provided between the shoulder regions BS of the user and the shoulder belts 22.

In the left and right pad portions 51L, 51R, respective attachment portions 52 for fixing the left and right shoulder belts 22 are provided. Each of the attachment portions 52 has, for example, a screw hole. The shoulder belts 22 are fixed to the left and right pad portions 51L, 51R by co-fastening the attachment portions 52 of the left and right pad portions 51L, 51R and the shoulder belts 22 with non-illustrated screws. In the center pad portion 51C, a fixing part 53 for fixing the control box 30 is provided. The fixing part 53 has, for example, a screw hole. The control box 30 is fixed to the center pad portion 51C by co-fastening the fixing part 53 with a non-illustrated screw. Where the control box 30 includes a plate-like base 31, the base 31 is fixed to the fixing part 53 of the center pad portion 51C.

With the above configuration, the shoulder belts 22, the stiff member 50 and the control box 30 are integrated. As described above, the first harness 11 may include the stiff member 50. The stiff member 50 serves as a stiff shoulder pad that is more rigid than the shoulder belts 22 and is to be hung on shoulder regions BS of a user. The stiff member 50 includes the left and right pad portions 51L, 51R provided along the respective shoulder belts 22. The first harness 11 including the stiff member 50 enhances a function that, when tension acts on the belt body 13, prevents the first harness 11 from slipping off the upper body of the user, by the first harness 11 being fitted to the shoulder regions BS of the user and the stiff member 50 being hung on the shoulder regions BS of the user. In particular, for example, when an output of the actuator 14 is high, the stiff member 50 effectively functions.

Although not illustrated, each of the left and right pad portions 51L, 51R may have a structure that enables length adjustment. In this case, the lengths of the pad portions 51L, 51R are adjusted respectively according to a body size of the user, enabling more effectively preventing slippage of the first harness 11.

Other Form of Connecting member 39

As above (see FIG. 4), the second belt 17 includes the left second belt portion 19, the right second belt portion 20 and the connecting member 39. The left second belt portion 19 is a part from the joining member 18 to the second harness 12 on the left leg region side. The right second belt portion 20 is a part from the joining member 18 to the second harness 12 on the right leg region side. The connecting member 39 connects the left second belt portion 19 and the right second belt portion 20.

In the form illustrated in FIGS. 4 and 8, each of the left second belt portion 19 and the right second belt portion 20 and the connecting member 39 are connected so as to rotate relative to each other via the relevant pins 39b, 39d. The connecting member 39 enables preventing an increase in lateral distance between the left second belt portion 19 and the right second belt portion 20 when a user changes his/her posture. The connecting member 39 having such function may take another form.

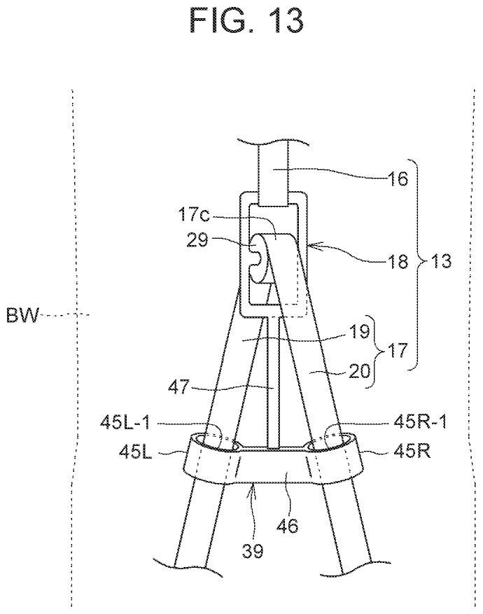

FIG. 13 is a diagram illustrating an alteration of the connecting member 39. The connecting member 39 includes a left support portion 45L, a right support portion 45R, a center support portion 46 and a hanging portion 47. The left support portion 45L includes a passage 45L-1 that allows the left second belt portion 19 to extend through the passage 45L-1. The left support portion 45L illustrated in FIG. 13 has a tubular shape, and the passage 45L-1 is formed of a through-hole extending in a height direction. The right support portion 45R includes a passage 45R-1 that allows the right second belt portion 20 to extend through the passage 45R-1. The right support portion 45R illustrated in FIG. 13 has a tubular shape, and the passage 45R-1 is formed of a through-hole extending in the height direction.

The center support portion 46 is a beam-like member interposed between the left support portion 45L and the right support portion 45R. The center support portion 46 connects the left support portion 45L and the right support portion 45R to prevent an increase in lateral distance between the left support portion 45L and the right support portion 45R. A lower portion of the hanging portion 47 is joined to the center support portion 46 and an upper portion of the hanging portion 47 is joined to the joining member 18. The hanging portion 47 is a column-like member that holds the center support portion 46 in such a manner that the center support portion 46 hangs from the joining member 18. The connecting member 39 may be made of, e.g., fabric or leather other than resin.

Upon the user walking, the left second belt portion 19 and the right second belt portion 20, which are folded at the joining member 18 (rotary pulley 29), each vary in length. The passages 45L-1, 45R-1 included in the connecting member 39 prevent restriction of displacement in a longitudinal direction of the left second belt portion 19 and the right second belt portion 20, respectively. The left support portion 45L and the right support portion 45R including such passages 45L-1, 45R-1 as above allow free movement in the longitudinal direction of the second belt 17. Then, the center support portion 46 enables preventing an increase in lateral distance between the left second belt portion 19 and the right second belt portion 20.

According to the above, for example, where the user changes his/her posture from an upright posture to a stooped posture as illustrated in FIG. 4, the connecting member 39 illustrated in FIG. 13 enables preventing an increase in lateral distance between the left second belt portion 19 and the right second belt portion 20. In other words, the connecting member 39 enables preventing a failure of the left second belt portion 19 and the right second belt portion 20 to extend along the respective back sides of leg regions BL of the user. In addition, movement in the longitudinal direction of the second belt 17 becomes smoother.

Alteration of First Harness 11

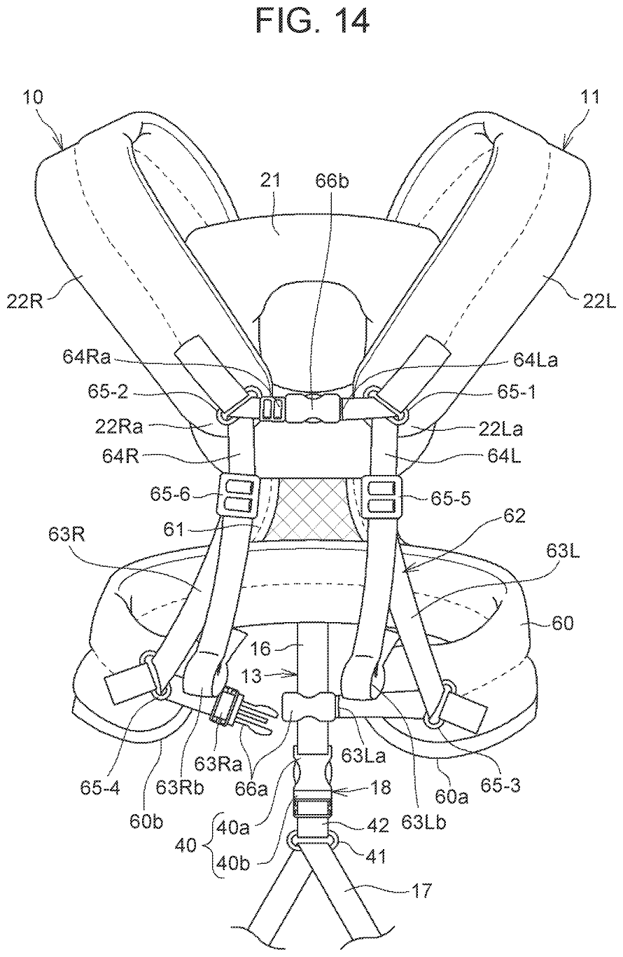

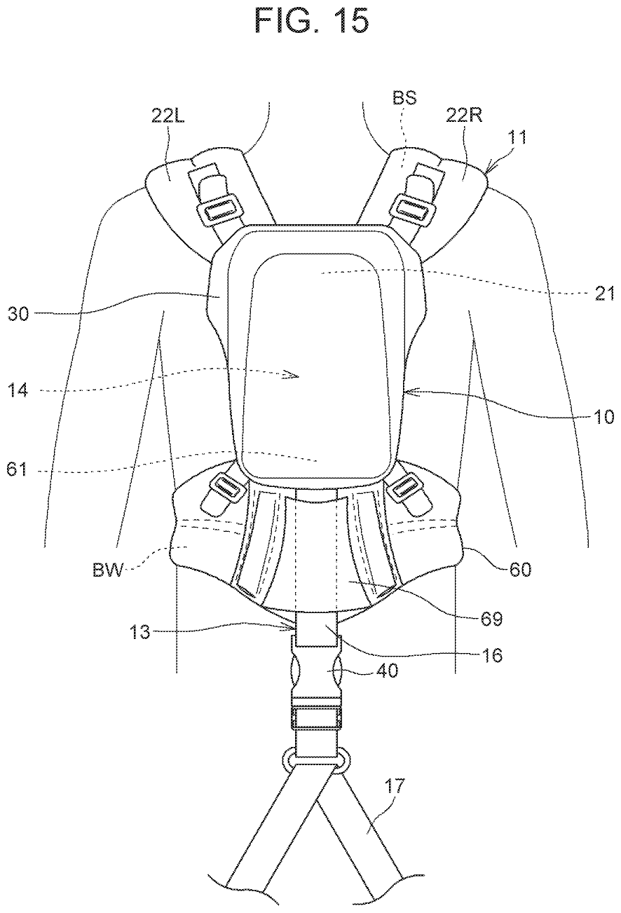

FIG. 14 is a diagram of an alteration of the first harness 11 and is a diagram of that first harness 11 as viewed from the front. FIG. 15 is a diagram of the first harness 11 illustrated in FIG. 14 as viewed from the back. FIG. 15 illustrates the first harness 11 fitted to a user. The first harness 11 illustrated in FIGS. 14 and 15 is fitted to shoulder regions BS of the user and also to a waist region BW of the user.

The first harness 11 include a back body portion 21 to be applied to the back of the user, left and right shoulder belts 22L, 22R, a waist belt 60 and a connecting member 61. Each of the back body portion 21, the shoulder belts 22L, 22R and the waist belt 60 is formed of, e.g., flexible fabric and can conform to the body shape of the user, and furthermore is cushioned (elastic), enabling reduction of a burden (pain) on the user. When the shoulder belts 22L, 22R are put on the shoulder regions BS, the back body portion 21 is held on the user's back. The waist belt 60 is wound around the waist region BW of the user. The connecting member 61 is a member connecting a lower portion of the back body portion 21 and a rear portion of the waist belt 60. The connecting member 61 is made of, for example, fabric and is flexible.

A rear end of the left shoulder belt 22L is joined to the upper left side of the back body portion 21 and a rear end of the right shoulder belt 22R is joined to the upper right side of the back body portion 21. In FIG. 14, the first harness 11 further includes an adjustment belt mechanism 62. The adjustment belt mechanism 62 includes a left-side first adjustment belt 63L, a right-side first adjustment belt 63R, a left-side second adjustment belt 64L and a right-side second adjustment belt 64R.

The adjustment belt mechanism 62 includes a plurality of resin or metal ring-like members that each allows a belt to extend through the ring-like member, which are called “slider buckles”. A first ring-like member 65-1 is attached to a front end portion 22La of the left shoulder belt 22L. A second ring-like member 65-2 is attached to a front end portion 22Ra of the right shoulder belt 22R. A third ring-like member 65-3 is attached to a left-side front end portion 60a of the waist belt 60. A fourth ring-like member 65-4 is attached to a right-side front end portion 60b of the waist belt 60. The adjustment belt mechanism 62 further includes a fifth ring-like member 65-5 joining the left-side first adjustment belt 63L and the left-side second adjustment belt 64L and a sixth ring-like member 65-6 joining the right-side first adjustment belt 63R and the right-side second adjustment belt 64R.

A buckle (fastener) 66a is provided between one end portion 63La of the left-side first adjustment belt 63L and one end portion 63Ra of the right-side first adjustment belt 63R. FIG. 14 illustrates a state in which the buckle 66a is unfastened. A buckle (fastener) 66b is provided between one end portion 64La of the left-side second adjustment belt 64L and one end portion 64Ra of the right-side second adjustment belt 64R. FIG. 14 illustrates a state in which the buckle 66b is fastened. The lower buckle 66a provides a state in which the first adjustment belts 63L, 63R are connected or a state in which the connection is undone. The upper buckle 66b provides a state in which the second adjustment belts 64L, 64R are connected or a state in which the connection is undone.

The first adjustment belt 63L is provided so as to extend upward through the third ring-like member 65-3 at an intermediate point of the first adjustment belt 63L, and further extends through the ring-like member 65-5 at another immediate point and hangs down. The other end portion 63Lb of the first adjustment belt 63L is looped. The other end portion 63Lb serves as a part to be held by the user with his/her hand to pull downward. The second adjustment belt 63R is provided so as to extend upward through the fourth ring-like member 65-4 at an intermediate point of the second adjustment belt 63R, and further extends through the ring-like member 65-6 at another intermediate point and hangs down. The other end portion 63Rb of the second adjustment belt 63R is looped. The other end portion 63Rb serves as a part to be held by the user with his/her hand to pull downward.

The adjustment belt mechanism 62 having the above configuration enables the user to easily take off the first harness 11 fitted to his/her body by unfastening the buckles 66a, 66b. Then, in order for the user to wear the first harness 11, it is only necessary to put on the left and right shoulder belts 22L, 22R and fasten the buckles 66a, 66b. In this way, the first harness 11 can easily be put on and taken off.

Furthermore, the user with the first harness 11 fitted thereto pulls down the other end portion 63Lb of the first adjustment belt 63L and the other end portion 63Rb of the first adjustment belt 63R with his/her hands. Then, a distance between the third ring-like member 65-3 and the fifth ring-like member 65-5 is reduced and a distance between the fourth ring-like member 65-4 and the sixth ring-like member 65-6 is reduced. As a result, a distance between the first ring-like member 65-1 and the third ring-like member 65-3 is reduced and a distance between the second ring-like member 65-2 and the fourth ring-like member 65-4 is reduced. In other words, a distance between the front end portion 22La of the left-side shoulder belt 22L and the left-side front end portion 60a of the waist belt 60 is reduced and a distance between the front end portion 22Ra of the right-side shoulder belt 22R and the right-side front end portion 60b of the waist belt 60 is reduced. Furthermore, a distance between the third ring-like member 65-3 and the fourth ring-like member 65-4 is also reduced by a force of the pulling-down. Consequently, the waist belt 60 is fastened. Furthermore, a distance between the first ring-like member 65-1 and the second ring-like member 65-2 is reduced by the pulling-down force. Consequently, left and right shoulder belts 22L, 22R are fastened. As above, the adjustment belt mechanism 62 enables the first harness 11 to be firmly fitted to the user, that is, the first harness 11 to be in close contact with the body of the user, and in addition, to be handled easily.

As illustrated in FIG. 15, an upper portion of the control box 30 is attached to the left and right shoulder belts 22L, 22R and a lower portion of the control box 30 is attached to the waist belt 60. The control box 30 are attached to the shoulder belts 22L, 22R and the waist belt 60 in such a manner that the control box 30 can be attached or detached via resin or metal ring-like members for allowing respective belts therethrough, which are called “buckles (fasteners)” or “slider buckles”.

In the assist device 10, upon the actuator 14 winding the belt body 13, an assist force that assists the user's work is generated by tension of the belt body 13. The tension causes the shoulder belts 22L, 22R to be subject to a downward force on the back side (rear side) of the user. The downward force causes an upward force to act on the shoulder belts 22L, 22R on the front side of the user. The upward force is transmitted to a front portion of the waist belt 60 through the first adjustment belts 63L, 63R and the second adjustment belts 64L, 64R and the upward force thus acts on the front portion of the waist belt 60.

Then, as described above (see FIG. 15), the control box 30 is connected also to the rear portion of the waist belt 60. Tension of the belt body 13 such as the above causes the control box 30 to be subjected to a downward force and the force is transmitted to the waist belt 60. As above, in the waist belt 60, a downward force acts on the rear portion of the waist belt 60 and an upward force acts on the front portion of the waist belt 60. The upward force transmitted from the shoulder belts 22L, 22R and acting on the waist belt 60 and the downward force transmitted from the control box 30 and acting on the waist belt 60 can be balanced, which prevents the first harness 11 from largely slipping off the body of the user.

The first harness 11 including the waist belt 60 enables applying an assist force to a user not only through the shoulder belts 22L, 22R but also through the waist belt 60, which provides for the user's ease. Also, a burden on the user due to the weight (self-weight) of the control box 30 is reduced by the waist belt 60. In this way, the first harness 11 including the waist belt 60 enables provision of an assist device 10 that provides good wear comfort and has high functionality.

The first harness 11 including the waist belt 60 may cause the user to take trouble in wearing the first harness 11. However, as described above, the adjustment belt mechanism 62 make it easy to put on and take off the first harness 11 and thus enables reduction in time for putting on and taking off the first harness 11. Also, the user can securely put on the first harness 11 with fewer actions.

In FIG. 14, the front end portion 22La of the left shoulder belt 22L, the front end portion 22Ra of the right shoulder belt 22R and the front end portions 60a, 60b of the waist belt 60 have respective configurations that can hide one or both of the respective buckles 66a, 66b and the respective ring-like members 65-1 to 65-4. For example, the front end portion 22La, etc., include a cover part or have a tubular shape. Consequently, for example, where a user wearing the assist device 10 performs work for assisting a care-receiver in a care facility, the buckles 66a, 66b and the ring-like members 65-1 to 65-4, which are relatively stiff, do not directly contact the body of the care-receiver (and the body of the user), which is favorable.

The waist belt 60 illustrated in FIG. 15 includes a cover 69 covering a part (first belt 16) of the belt body 13. The cover 69 is attached to a body part of the waist belt 60, and the part of the belt body 13 extends between the body part and the cover 69. For example, when a user lifts a care-receiver up in his/her arms, the care-receiver often has his/her arms behind the back of the user. In this case, the care-receiver's hands may touch the belt body 13, which may hinder operation of the belt body 13. However, the cover 69 makes the care-receiver be less likely to touch the belt body 13.

Alteration of Joining Member 18

An alteration of the joining member 18 joining the first belt 16 located on the upper body side and the second belt 17 located on the lower body side will be described with reference to FIGS. 14 and 15. The joining member 18 includes a fastener 40 such as a buckle, and a ring-like body 41 having, for example, a rectangular shape, which is called “rectangular ring”. The fastener 40 includes a first member 40a and a second member 40b that can be separated and joined. By a user pinching a part of the fastener 40 with his/her fingers, the first member 40a and the second member 40b joined together are separated from each other. Also, the first member 40a and the second member 40b are joined by being fitted together.

An end portion of the first belt 16 is attached to the first member 40a. The second member 40b and the ring-like body 41 are connected by a short connection belt 42. The second belt 17 is hung on the ring-like body 41. The second belt 17 is folded on the ring-like body 41 at an intermediate point of the second belt 17 and the second belt 17 is supported so as to be movable in a longitudinal direction of the second belt 17. As above, the joining member 18 illustrated in FIGS. 14 and 15 includes the fastener 40, which is a first attachment portion to which the end portion of the first belt 16 is attached, and a ring-like body 41, which is a second attachment portion that supports the second belt 17 in such a manner that the second belt 17 is folded at an intermediate point of the second belt 17 and is movable in the longitudinal direction. Note that the second member 40b may be integrated with the ring-like body 41. In other words, a loop portion (hole portion) included in a second member 40b as a part may be a ring-like body on which the second belt 17 is hung, without using the rectangular ring. In this case, the short connection belt 42 is omitted.

The joining member 18 having such configuration as above enables the first belt 16 and the second belt 17 to be easily separated. Also, the first belt 16 and the second belt 17 can easily be joined. For example, the second belt 17 can be replaced with one that is different in entire length, enabling a length of the second belt 17 to be easily changed according to the body size (body height) of the user. Also, where only one of the first belt 16 and the second belt 17 is deteriorated, only the deteriorated belt may be replaced without replacement of the entire belt body 13. Also, when the second belt 17 is to be cleaned, the second belt 17 can easily be separated from the first belt 16.

As described with reference to FIG. 13, the second belt 17 may include a connecting member 39 connecting a left second belt portion 19 and a right second belt portion 20. The connecting member 39 includes a left support portion 45L including a passage that allows the left second belt portion 19 to extend through the passage, a right support portion 45R including a passage that allows the right second belt portion 20 to extend through the passage, and a center support portion 46 connecting the left support portion 45L and the right support portion 45R. Note that in the form illustrated in FIG. 13, the hanging portion 47 extending from the joining member 18 is provided, the hanging portion 47 may take another form (separate from the joining member 18) or the hanging portion 47 may be omitted.

Accessories to Harnesses

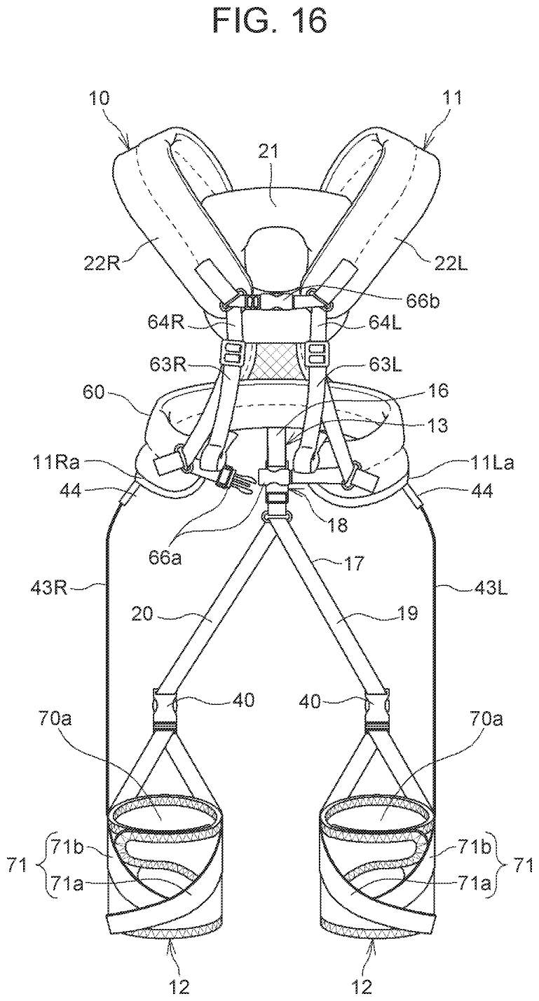

FIG. 16 is an overall view of an assist device 10 including a first harness 11 and second harnesses 12. As described above, the second harnesses 12 for legs are joined to a belt body 13 (a first belt 16 and a second belt 17) extending from the first harness 11 side, which is fitted to the upper body, and are thus integrated with the first harness 11. Therefore, a user fits the first harness 11 and the second harness 12 integrated together to the upper body and the leg regions. However, since the belt body 13 is flexible, before the fitting, the left and right second harnesses 12 are free from the first harness 11. Therefore, when the user wears the assist device 10, the belt body 13 may be twisted and the left-leg second harness 12 may come to the right side and the right-leg second harness 12 may come to the left side. In this case, an error in wearing is likely to occur, which causes a waste of time.

Therefore, as illustrated in FIG. 16, the assist device 10 includes a left-side string member 43L connecting a left-side portion 11La of the first harness 11 (waist belt 60) and the left-leg second harness 12, and a right-side string member 43R connecting a right-side portion 11Ra of the first harness 11 (waist belt 60) and the right-leg second harness 12. Each of the string members 43L, 43R includes a fastener 44 such as a tubular buckle at the intermediate points of the string members 43L, 43R. Unfastening the fasteners 44 enables preventing hindrance of separation between the first harness 11 and the second harnesses 12.

The string members 43L, 43R make it easy for the left-leg second harness 12 to come to the left side and for the right-leg second harness 12 to come to the right side when the user puts on the assist device 10. Therefore, time for putting on the assist device 10 can be reduced. Also, lengths of the string members 43L, 43R are set in such a manner that the left and right second harnesses 12, 12 that hang from the first harness 11 when the first harness 11 is fitted to the upper body of the user are located around knee regions of the user. Consequently, the second harnesses 12 can easily be put on. Note that each of the string members 43L, 43R is formed by, for example, an elastic member and thus is less likely to hinder movement of the user.

Alteration of Second Harnesses 12

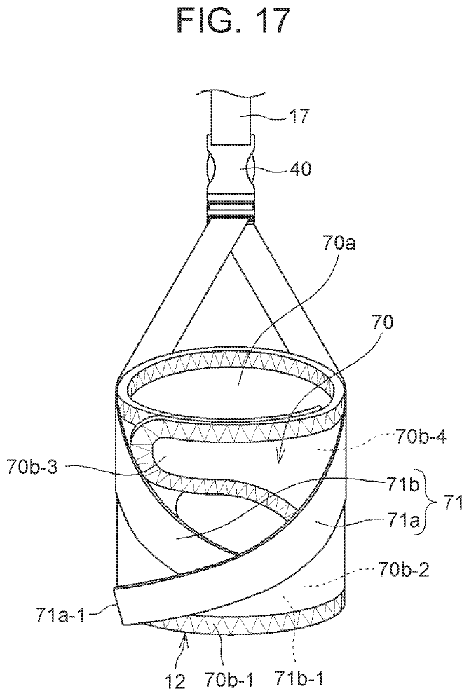

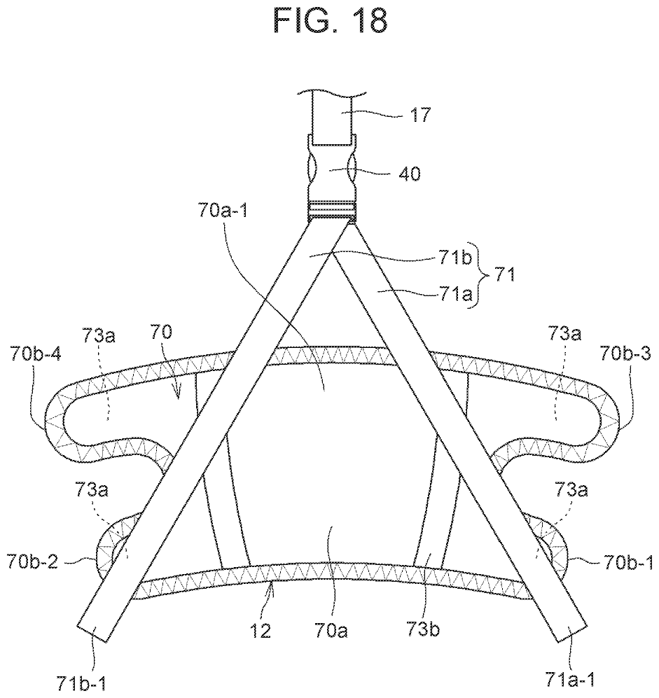

FIG. 17 is a diagram of a second harness 12 for a leg. FIG. 17 is an imaginary diagram of a second harness 12 in a state of being fitted to a leg region (knee region) of a user. FIG. 18 is a diagram illustrating a developed state of the second harness 12 illustrated in FIG. 17. Note that FIG. 18 is a diagram of the second harness 12 in a developed state before being fitted to a leg region of a user, as viewed from behind. The second harness 12 includes a band-like body 70 to be wrapped around a leg region of a user and a transmission belt 71 to be fixed to the band-like body 70. A left-leg second harness 12 and a right-leg second harness 12 have a same configuration.

The band-like body 70 is an elastic band-like member and is stretchable. The band-like body 70 is formed by, for example, an elastic fabric member. On the other hand, the transmission belt 71 is a belt formed of a non-elastic body and is non-stretchable. The transmission belt 71 is made of, for example, a material that is the same as that of the belt body 13 (the first belt 16 and the second belt 17).

As illustrated in FIG. 18, the band-like body 70 has a configuration that can be developed on a plane and has a shape in which a dimension in a left-right direction is larger than a dimension in a height direction in a developed state. The band-like body 70 includes a center band body portion 70a, and four fastening band portions 70b-1, 70b-2, 70b-3, 70b-4 extending from upper and lower positions on opposite, left and right, sides of the band body portion 70a, respectively. A one-side member 73a of a hook-and-loop fastener is fixed to one side of each of parts of the band-like body 70, the parts including the fastening band portions 70b-1, 70b-2, 70b-3, 70b-4. The entire other side of the band-like body 70 forms an other-side member 73b of the hook-and-loop fastener. It is needless to say that the one-side member 73a and the other-side member 73b are attachable to and detachable from each other. As illustrated in FIG. 17, the band-like body 70 is fitted to a leg region (knee region) of a user via the hook-and-loop fastener by winding the band-like body 70 around the leg region (knee region) of the user.

The transmission belt 71 is connected to one side of a fastener 40, such as a buckle, at a center portion in a longitudinal direction of the transmission belt 71. An end portion of the second belt 17 is connected to the other side of the fastener 40. The second belt 17 and the second harness 12 can be separated from each other by separating the one side and the other side of the fastener 40 from each other.

The transmission belt 71 includes a one-side belt portion 71a and an other-side belt portion 71b with the fastener 40 as a center. The one-side belt portion 71a is fixed within a range from the first fastening band portion 70b-1 located on the lower side of one side (right side in FIG. 18) in the right-left direction of the band-like body 70 to an upper center portion 70a-1 of the band body portion 70a. The one-side belt portion 71a is provided so as to protrude from the first fastening band portion 70b-1. The other-side belt portion 71b of the transmission belt 71 is fixed within a range from the second fastening band portion 70b-2 located on the lower side of the other side (left side in FIG. 18) in the right-left direction of the band-like body 70 to the upper center portion 70a-1 of the band body portion 70a. The other-side belt portion 71b is provided so as to protrude from the second fastening band portion 70b-2.

Upon the band-like body 70 having the above configuration being fitted so as to be wound around a leg region (knee region) of a user, as illustrated in FIG. 17, the band body portion 70a takes a tubular shape, and the one-side belt portion 71a of the transmission belt 71 is helically disposed halfway around the band body portion 70a in one direction, and the other-side belt portion 71b of the transmission belt 71 is helically disposed halfway around the band body portion 70a in the other direction. A one-side member of a hook-and-loop fastener is fixed to a protruding extension part 71a-1 of the one-side belt portion 71a, enabling the extension part 71a-1 to be attached to the other side of the band-like body 70. A one-side member of a hook-and-loop fastener is fixed to a protruding extension part 71b-1 of the other-side belt portion 71b, enabling the extension part 71b-1 to be attached to the other side of the band-like body 70.

Here, a case where each second harness 12 includes no transmission belt 71 and includes a band-like body 70 made of a highly-elastic material and a part of the band-like body 70 is directly joined to a second belt 17 will be described. In this case, upon an actuator 14 of an assist device 10 operating and tension acting on the second belt 17, a force generated by the tension causes deformation and stretching of the band-like body 70, which may result in a failure to correctly transmit a force for assist operation to a leg region (knee region) of a user. However, with the second harness 12 illustrated in FIGS. 17 and 18, tension acting on the second belt 17 is transmitted to the transmission belt 71. The transmission belt 71 is fixed to the band-like body 70 via, for example, sewing. Therefore, a force acting on the second belt 17 is correctly transmitted to a leg region (knee region) of a user through the transmission belt 71. Therefore, an assist force of the assist device 10 is properly provided to the user.

Others

For prevention of pain in the lower back of a user, it is preferable that the second harnesses 12 be fitted to leg regions BL. This is because a load on a waist region BW can be reduced by the second harnesses 12 being fitted to leg regions BL. In each form of assist device 10, the belt body 13 is light in weight and can conform to the body of a user even if the user changes his/her posture, and thus follows movement of the user. Therefore, an assist device 10 that provides good wear comfort can be provided. Note that in the above disclosure, the control box 30 is provided on the rear side (back side) of a user in the first harness 11 but may be provided on the front side of a user. In this case, the belt body 13 is provided along the back of the user through shoulder regions BS of the user.

The embodiment disclosed herein is a mere example in every respect and is not limiting. The scope of the right for the present disclosure is not limited to the above embodiment but includes all changes that come within the meaning and range of equivalency of the claims.

What is claimed is:

1. An assist device comprising:
a first harness configured to be fitted to at least one of a shoulder region and a breast region of a user;
a second harness configured to be fitted to a leg region or a waist region of the user;
a belt body provided so as to extend to the first harness and to the second harness along a back side of the user; and
an actuator provided in the first harness or the second harness and configured to wind and unwind a part of the belt body.

2. The assist device according to claim 1, wherein
the assist device includes a plurality of the second harnesses, and
the second harnesses are configured to be fitted respectively to right and left legs of the user.

3. The assist device according to claim 1, wherein the belt body is non-stretchable.

4. The assist device according to claim 1, wherein:
the actuator is provided in the first harness; and
the belt body includes a first belt, a second belt attached to the second harness, and a joining member joining the first belt and the second belt, the first belt being configured to be wound and unwound by the actuator.

5. The assist device according to claim 4, wherein the joining member includes a first attachment portion to which an end portion of the first belt is attached, and a second attachment portion configured to support the second belt in such a manner that the second belt is folded at an intermediate point of the second belt and moves in a longitudinal direction of the second belt, and one end portion side of the second belt is attached to the second harness on the left leg region side and another end portion side of the second belt is attached to the second harness on the right leg region side.

6. The assist device according to claim 5, wherein the second attachment portion includes a shaft portion integrated with the first attachment portion, and a rotary pulley supported on the shaft portion, the second belt being hung on the rotary pulley in such a manner that the second belt is folded at an intermediate point of the second belt.

7. The assist device according to claim 5, wherein the second belt includes a left second belt portion extending from the joining member to the second harness on the left leg region side, a right second belt portion extending from the joining member to the second harness on the right leg region side, and a connecting member connecting the left second belt portion and the right second belt portion.

8. The assist device according to claim 7, wherein:
the connecting member and the left second belt portion are joined so as to rotate relative to each other; and
the connecting member and the right second belt portion are joined so as to rotate relative to each other.

9. The assist device according to claim 7, wherein the connecting member includes a left support portion including a passage configured to allow the left second belt portion to extend through the passage, a right support portion including a passage configured to allow the right second belt portion to extend through the passage, a center support portion connecting the left support portion and the right support portion, and a hanging portion configured to hold the center support portion in such a manner that the center support portion hangs from the joining member.

10. The assist device according to claim 1, wherein:
the first harness includes a shoulder belt having flexibility and a stiff member that is more rigid than the shoulder belt and is to be hung on the shoulder region of the user; and
the stiff member includes a pad portion provided along the shoulder belt.
